(19) United States
(12) Patent Application Publication
(10) Pub. No.: US 2018/0142189 A1
(43) Pub. Date: May 24, 2018

(54) CONTAINER WASHING AND DETERGENT FOR USE THEREOF

(71) Applicant: DIVERSEY, INC., Charlotte, NC (US)

(72) Inventors: Nathalie Catherine Gerard, Plankstadt (DE); Walter John Watkinson, Matlock (GB); Petr Basar, Praha (CZ); Christian Selle, Ludwigshafen (DE)

(21) Appl. No.: 15/571,944

(22) PCT Filed: Apr. 29, 2016
(86) PCT No.: PCT/US2016/030146

§ 371 Date: Nov. 6, 2017

Related U.S. Application Data
(60) Provisional application No. 62/158,032, filed on May 7, 2015.
(60) Provisional application No. 62/241,781, filed on Oct. 15, 2015.

(51) Int. Cl. C11D 11/00; C11D 3/04; C11D 3/20; C11D 3/43; C11D 1/66

(52) U.S. Cl. CPC C11D 11/0035; C11D 11/0064; C11D 3/042; C11D 1/66; C11D 3/2065; C11D 3/2075; C11D 3/43; C11D 3/044

(57) ABSTRACT

The presently disclosed subject matter is directed to acidic disinfecting and/or cleaning compositions that comprise an acid, a solvent, a nonionic surfactant and optionally one or more additives. The disclosed compositions can be used to clean and/or disinfect a wide variety of products (such as bottles) in the food, dairy, beverage, brewery, and soft drink industries.

### CROSS-REFERENCE TO RELATED APPLICATIONS

This is a National Stage of International Application No. PCT [symbol] JS2016/030146 filed Apr. 29, 2016, claiming the benefit of and priority from U.S. Provisional Application No. 62/158,032 filed May 7, 2015, and U.S. Provisional Application No. 62/241,781 filed Oct. 15, 2015.

### FIELD OF THE INVENTION

The presently disclosed subject matter relates to methods of cleaning and/or disinfecting containers (glass bottles, for example), such as for use in the food, dairy, beverage, brewery, and soft drink industries. The presently disclosed subject matter further relates to detergent compositions used in the disclosed cleaning and/or disinfecting methods.

### BACKGROUND

Containers, particularly glass bottles used for soft drinks and beer, are frequently reused in the bottling industry. In such cases, the container must be cleaned and disinfected once returned to the bottler, which is accomplished using a bottlewashing apparatus. Typically, the containers are first pre-rinsed to remove large particles and then are conveyed to a cleaning section where they are soaked in a highly caustic solution at an elevated temperature, generally about 75° C. or higher. After approximately 7 to 15 minutes, the containers are taken to a warm rinse, and then to a final potable water rinse. Conventionally, the cleaning solution is highly caustic and contains about 1-4% sodium hydroxide. The caustic detergent in combination with the high cleaning temperature and long contact time act to clean the containers and render them commercially sterile.

However, it has been shown that the standard caustic bottlewash process is chemically aggressive on containers such as glass bottles. The level of causticity is sufficient to partially dissolve the glass matrix over time at normal bottlewash temperatures. Scratches on the surface of the glass increase the surface area for the caustic to attack, which increases the dissolution of the glass. As a result, any scratches appear larger, which in turn makes the bottles appear aesthetically unappealing. Eventually, the appearance of the bottles can become so unacceptable to consumers that they must be discarded before their useful life is over.

When glass is dissolved by standard caustic bottlewashing methods, silica is released, making it available to react with other materials in the wash solution, thereby forming silicates. Silicates frequently build up on the washing equipment as silicate scale, which is extremely difficult to remove. Particularly, the bottlewasher must be shut down and emptied to remove the equipment scale, causing a loss in productivity.

The presently disclosed subject matter is directed to an acid-based or caustic-based detergent that can be used in the bottlewashing process at reduced temperatures, thereby providing suitable cleaning capabilities as well as increased energy savings.

### SUMMARY

In some embodiments of the invention, the presently disclosed subject matter is directed to an acidic detergent composition and a caustic solution. Particularly, the acidic detergent composition comprises about 1-60 weight percent acid, about 1-60 weight percent solvent, and about 1-10 weight percent nonionic surfactant, based on the total weight of the detergent composition.

According to an embodiment of the invention, the acidic cleaning using the acidic detergent composition occurs at 30-60° C. for a period of 1-15 minutes. In certain other embodiments of the invention, acidic cleaning is followed by a caustic cleaning using a caustic solution. According to certain embodiments of the invention, the caustic cleaning may occur at 30-60° C. for a period of from 0.5-15 minutes.

In some embodiments, the presently disclosed subject matter is directed to a method of cleaning a container. Specifically, the method comprises an acidic cleaning of the container with the disclosed acidic detergent at 30-60° C. for 1-15 minutes, followed by rinsing the container with water. According to an embodiment of the invention, the method further comprises a caustic cleaning of the container using caustic solution at 30-60° C. for 0.5-15 minutes followed by rinsing the container with potable water.

Another aspect of the invention provides a detergent comprising an acidic-based detergent having about 1-60 weight percent of an acid, about 1-60 weight percent of a solvent, and about 1-10 weight percent of a nonionic surfactant, based on the total weight of the composition; and a caustic-based detergent. In certain embodiments of the invention, the acid-based detergent is applied at 30-60° C. for 1-15 minutes and the caustic-based detergent is applied at 30-60° C. for 0.5-15 minutes.

Other aspects and embodiments will become apparent upon review of the following description taken in conjunction with the accompanying drawing. The invention, though, is pointed out with particularity by the included claims.

### BRIEF DESCRIPTION OF THE DRAWINGS

FIG. 1 is a graphical representation of the percentage of clean bottles per bottle section after methylene blue tinting.

### DETAILED DESCRIPTION

### I. General Considerations

The presently disclosed subject matter is directed to acidic disinfecting and/or cleaning compositions that comprise an acid, a solvent, a nonionic surfactant, and optionally one or more sequestrants. The disclosed compositions can be used in cleaning and/or disinfecting systems for cleaning a wide variety of products, including (but not limited to) bottle washing in the food, dairy, beverage, brewery, and soft drink industries. The presently disclosed subject matter further relates to methods of cleaning and/or disinfecting a container using the disclosed compositions, as set forth in more detail herein below.

### Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long standing patent law convention, the terms “a”, “an”, and “the” refer to “one or more” when used in the subject application, including the claims. Thus, for example, reference to “a composition” includes a plurality of such compositions, and so forth.

Unless indicated otherwise, all numbers expressing quantities of components, reaction conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, percentage, and the like can encompass variations of, and in some embodiments, ±20%, in some embodiments ±10%, in some embodiments ±5%, in some embodiments ±1%, in some embodiments ±0.5%, and in some embodiments ±0.1%, from the specified amount, as such variations are appropriated in the disclosed composition and methods.

The term “sequestrant” as used herein refers to any materials that have more than one atom with a lone pair of electrons that are available to bond to a metal ion. Suitable sequestrants include (but are not limited to) EDTA, EGTA, NTA, DTPA, HEIDA, IDS, MGDA, GLDA, GLUDA, gluconic acid and/or gluconates, 2,2′-bipyridyl, phosphonic acid, complex phosphates, phosphonates (including a wide variety of phosphonic acids and phosphonate salts known and used in the art, such as PBTC, HEDP, ATMP, and the like), and mixtures and/or salts thereof.

The term “surfactant” as used herein refers to any agent that can lower the surface tension of a liquid. Suitable surfactants can include (but are not limited to) cationic surfactants, nonionic surfactants, anionic surfactants, biocides, dyes, colorants, and amphoteric (zwitterionic) surfactants.

As used herein, the term “use solution” refers to a composition with ingredients found at the concentration intended for use.

All compositional percentages used herein are presented on a “by weight” basis, unless designated otherwise.

Although the majority of the above definitions are substantially as understood by those of skill in the art, one or more of the above definitions can be defined herein above in a manner differing from the meaning as ordinarily understood by those of skill in the art, due to the particular description herein of the presently disclosed subject matter.

### III. The Presently Disclosed Composition

III.A. Generally

As set forth above, the disclosed cleaning/disinfecting solutions comprise an acid, a solvent, and a nonionic surfactant. Particularly, the disclosed compositions comprise about 1-60 weight percent acid, about 1-60 weight percent solvent, and about 1-10 weight percent nonionic surfactant, based on the total weight of the composition. Further, the disclosed composition optionally comprises at least one additive, such as (but not limited to) sequestrant, surfactant, buffer, and combinations thereof. In these embodiments, the composition can comprise about 1-5 weight percent additive, based on the total weight of the composition.

The disclosed composition can be present in the form of a concentrate or a diluted use solution. For example, in some embodiments a cleaning and/or disinfecting solution can be prepared by diluting the disclosed composition with a food grade diluent, such as water, in a ratio of from about 1:10 to about 1:500 (composition to diluent). Thus, in some embodiments, the disclosed composition can be diluted in a ratio of about 1:30 to about 1:400; in some embodiments, about 1:50 to about 1:300; and in some embodiments, about 1:50 to about 1:100 (composition to diluent). The diluted composition can therefore in some embodiments be diluted to a concentration of about 1 to 5000 ppm; in some embodiments, about 10 to 1500 ppm. Thus, in some embodiments, the use concentration is about 1-4 weight percent (i.e., about 1, 2, 3, or 4, weight percent) composition, based on the total weight of the use solution.

The disclosed composition has a pH of about 0.25-4 upon dilution to the use solution. Thus, the pH of the disclosed composition can be at least about (or no more than about) 4.0, 3.75, 3.5, 3.25, 3.0, 2.75, 2.5, 2.25, 2.0, 1.75, 1.5, 1.25, 1.0, 0.75, 0.5, or 0.25 after dilution to the use solution.

III.B. Acid

As set forth herein above, the disclosed composition comprises about 1-60 weight percent acid, based on the total weight of the composition. The acid can comprise any of the wide variety of acids known and used in the art, including (but not limited to) one or more of the following: phosphoric, sulfuric, sulfamic, methylsulfamic, hydrochloric, hydrobromic, hydrofluoric, nitric, hydroxyacetic (glycolic), citric, lactic, formic, acetic, propionic, butyric, valeric, caproic, gluconic, itaconic, trichloroacetic, urea hydrochloride, benzoic, oxalic, maleic, fumaric, adipic, terephthalic peroxyacetic acid tartaric acid, bromoacetic acid, and/or peroxyoctanoic acid.

In some embodiments, the acid can be present in the composition at about 1-60 weight percent; 10-58 weight percent; 20-57 weight percent; or about 40-55 weight percent. Thus, in some embodiments, the disclosed composition comprises no more (or no less than) about 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1, weight percent acid, based on the total weight of the composition. For example, in some embodiments, the acid can be present at about 51-52 weight percent, based on the total weight of the composition.

III.C. Solvent

The disclosed composition comprises about 1-60 weight percent solvent, as described above. The solvent can be any of the wide variety of solvents known and used in the art, including (but not limited to) water, diglycol, ethanol, isopropanol, 1,2-propylene glycol, butylene glycol, propanol, butanol, isobutanol, benzyl alcohol, ethylene glycol, diethylene glycol, butyl diglycol (diethylene glycol butyl ether), propylene glycol, ethylene glycol phenyl ether, propylene glycol phenyl ether, propylene glycol methyl ether, propylene glycol propyl ether, dipropylene glycol methyl ether, diethylene glycol methyl ether, diethylene glycol ethyl ether, triethylene glycol methyl ether, and combinations thereof.

In some embodiments, the solvent can be present in the composition at about 1-60 weight percent; 10-55 weight percent; 20-50 weight percent; or about 40-50 weight percent. Thus, in some embodiments, the disclosed composition comprises no more (or no less than) about 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1, weight percent solvent, based on the total weight of the composition.

III.D. Nonionic Surfactant

As set forth above, the disclosed compositions comprise about 1-10 weight percent nonionic surfactant, based on the total weight of the composition. The nonionic surfactant can be selected from any of the wide variety of nonionic surfactants known and used in the art, including (but not limited to) polyvinyl alcohol, polyalkene oxides, polyalkylene oxides, alkanoamide, alkyl polyethylene oxide, alkylphenol polyethylene oxide, polyoxyethylenated alkyl amine oxide, polyoxyethylenated polyoxypropylene glycols, alkyl polyglucoside, alkyl carboxylic acid esters, polyoxyethylenated mercaptans, alkyl diglyceride, polyoxyethylenated alkanolamine, polyalkoxylated amides, tertiary acetylenic glycols, t-octylphenoxypolyethoxyethanol, polyoxyethylenesorbitan monolaurate, polyoxyethylenesorbitan monolaurate, polyoxyethylenesorbitan monopalmitate, polyoxyethylenesorbitan monostearate, polyoxyethylenesorbitan monooleate, polyoxyethylenesorbitan monotrioleate, (octylphenoxy) polyethoxyethanol, triethyleneglycol monolauryl ether, sorbitan monolaurate, and combinations thereof.

In some embodiments, the nonionic surfactant can be present in the composition in an amount of from about 1-10 weight percent, based on the total weight of the composition. Thus, in some embodiments, the composition can comprise no more than (or no less than) about 1, 2, 3, 4, 5, 6, 7, 8, 9, or 10 weight percent nonionic surfactant, based on the total weight of the composition.

III.E. Additives

The disclosed composition optionally comprises one or more additives, as would be known in the art. As set forth above, the disclosed additive can comprise about 0.1-5 weight percent of the composition, based on the total weight of the composition. Thus, the additive can be present in the composition in an amount of no more than (or no less than) about 0.1, 0.5, 1.0, 1.5, 2.0, 2.5, 3.0, 3.5, 4.0, 4.5, or 5.0 weight percent, based on the total weight of the composition.

Suitable additives can be selected from the group comprising one or more surfactants (anionic, nonionic), sequestrants, preservatives, buffers, biocides, dyes, colorants, and the like. For example, suitable biocides can include (but are not limited to) octenyl succinic anhydride, salicylic acid, and other generally acceptable biocides for detergents.

### IV. Methods of Using the Disclosed Composition

The disclosed compositions can be successfully employed for cleaning and/or disinfecting containers (such as glass bottles, refillable PET, and the like) in bottlewashing and processing facilities, such as those used in the dairy, brewery, and beverage industries. The disclosed compositions advantageously exhibit effective cleaning and/or disinfecting activity at temperatures of 60° C. or less. Specifically, the presently disclosed subject matter comprises a 2-step method of cleaning and/or disinfecting containers (such as glass bottles). In some embodiments, the disclosed method is accomplished through the use of a bottlewashing machine.

The first step of the disclosed method comprises acidic cleaning with the disclosed detergent described herein above. Particularly, the acidic cleaning step can take place at reduced temperatures of about 30-60° C. for about 1-15 minutes. Thus, the acidic cleaning step can occur at temperatures of no more than (or no less than) about 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., or 60° C. for no more than (or no less than) about 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, or 15 minutes. After the acidic cleaning step has been completed, the containers can be rinsed with water.

The container is then cleaned with caustic solution at reduced temperatures of about 30° C. to 60° C. for about 0.5 to 15 minutes. Thus, the second cleaning step can occur at temperatures of no more than (or no less than) about 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., or 60° C. for no more than (or no less than) about 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, or 15 minutes.

Suitable caustic solutions for use in the second cleaning step can comprise (but are not limited to) NaOH, LiOH, KOH, NH₄OH, Mg(OH)₂, Ca(OH)₂, and combinations thereof. In some embodiments, the caustic solution can comprise one or more additives (based on surfactant and/or sequestrant) to improve the detergency and/or control foam. The typical use concentration of the additive is about 0.1-2 weight percent, based on the total weight of the caustic solution. In some embodiments, the use concentration of the caustic solution can be about 1-3 weight percent. In some embodiments, the pH of the caustic solution is more than about 13. Either before, after, or both before and after the second cleaning step is complete, the disclosed method can comprise a rinsing step, wherein the containers are rinsed with water (such as potable water), aqueous buffer, or the like.

It has been surprisingly discovered that when containers (such as glass bottles) are cleaned and/or disinfected with the disclosed method, they are at least as clean as containers washed using conventional methods used in the art (i.e., that use high temperatures and caustic detergents). In some embodiments, the disclosed method cleans at least as well as industry standard cleaning methods (i.e., about 99% or more bottles cleaned).

The disclosed methods can optionally comprise one or more additional cleaning, rinsing, or pre-cleaning steps in addition to the first and second steps described above.

The disclosed method can be employed in any of the wide variety of cleaning and/or disinfecting systems known in the art.

### V. Advantages of the Presently Disclosed Subject Matter

The presently disclosed method enables effective cleaning of containers at temperatures of 60° C. or less compared to cleaning temperatures of about 75° C. to about 80° C. or greater used in conventional cleaning operations, leading to energy savings for the customer.

In addition, the reduced cleaning temperature and acidic detergent composition reduce glass etching to effectively increase the life of the containers.

Further, by using cleaning methods that employ spraying instead of soaking and spraying, users can realize large water savings as well as reduction in processing times.

### EXAMPLES

The following Examples provide illustrative embodiments. In light of the present disclosure and the general level of skill in the art, those of ordinary skill in the art will appreciate that the following Examples are intended to be exemplary only and that numerous changes, modifications, and alterations can be employed without departing from the scope of the presently disclosed subject matter.

### Example 1

### Testing of Cleaning Method

Solution 1 (acidic) was prepared according to Table 1 below. Solution 2 (caustic) was prepared by diluting sodium hydroxide to 2% with water and adding an additive based on EDTA to 0.5%.

For the tested method, a pilot bottle washing apparatus containing a spray nozzle with a throughput of 8L/minute, a bottle holder, a flow meter, and a pump were used. For the first cleaning step, Solution 1 (the acidic detergent) at 40° C. was sprayed for 3 minutes into the bottle. The bottle was then rinsed with water prior to the second cleaning step. During the second cleaning step, Solution 2 (the caustic solution) at 60° C. was sprayed into the bottle for 90 seconds. The bottles were then rinsed with water.

TABLE 1
Formulation of Solution 1

| Component | Weight % |
|---|---|
| Water | 11.5 |
| Phosphoric acid (75%) | 60.0 |
| Glycolic acid (70%) | 9.0 |
| Diethyleneglycol butylether | 9.0 |
| Alcohol (C10-guerbet) ethoxylate (3EO) | 1.5 |
| Alkyl (C8-12) propoxylate (10PO) | 1.0 |
| Aminotrimethylene phosphonic acid (50%) | 1.0 |
| Alkyl (C8) ether (8EO) carboxylic acid (88%) | 2.0 |
| EDTA 4Na-salt (40%) | 5.0 |

TABLE 2
Visual Cleanliness Results

| Bottle No. | Bottle Neck | Bottle Shoulder | Bottle Side | Bottle Base |
|---|---|---|---|---|
| 1 | 0 | 0.5 | 0 | 0 |
| 2 | 0 | 0 | 0 | 0.5 |
| 3 | 0.5 | 1 | 1 | 0.5 |
| 4 | 1 | 0 | 0 | 0 |
| 5 | 0 | 0 | 0 | 0 |
| 6 | 0 | 0 | 0 | 0 |
| 7 | 0.5 | 1 | 1 | 0 |
| 8 | 0 | 0.5 | 0.5 | 0 |

After acid cleaning followed by caustic cleaning with Solutions 1 and 2, the bottles were visually inspected and rated using the following rating system: 0=soil completely removed; 0.5=one small spot; 1=soil partly removed (small residue); 2=soil not completely removed (obvious residue); 3=soil not removed (massive residue). The results are given below in Table 2.

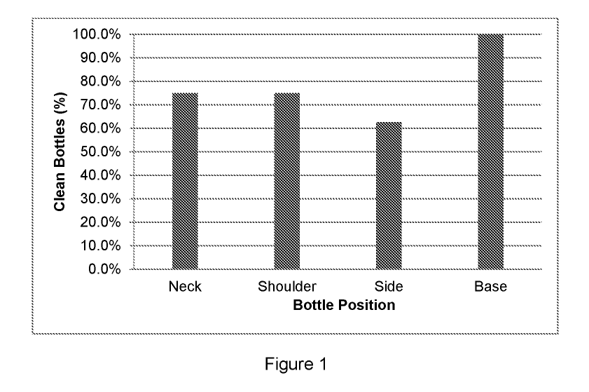

The bottles were then tinted with methylene blue and were again visually inspected and rated using the following rating system: 0=clean; 0.5=one very small spot; 1=spots and small areas; 2=extended areas; 3=dark and wide areas. The results are given below in Table 3. The percentage of clean bottles (per bottle section) after methylene blue tinting is represented graphically in FIG. 1, where ratings of 0 and 0.5 are considered clean.

TABLE 3
Methylene Blue Cleanliness Results

| Bottle No. | Bottle Neck | Bottle Shoulder | Bottle Side | Bottle Base |
|---|---|---|---|---|
| 1 | 0 | 0.5 | 0 | 0.5 |
| 2 | 0 | 0 | 0 | 0 |
| 3 | 1 | 1 | 1.5 | 0.5 |
| 4 | 1.5 | 0.5 | 0 | 0 |
| 5 | 0 | 0 | 0 | 0.5 |
| 6 | 0 | 0 | 0 | 0 |
| 7 | 0 | 1.5 | 1 | 0 |
| 8 | 0 | 0 | 1 | 0 |

Summary of the Results from Example 1

Methylene blue is a sensitive method to indicate the presence of residual organic soils not always visible by the human eye, which explains why the scoring in Table 3 is slightly higher than the scoring in Table 2.

Tables 2 and 3 indicate that the bottle bottom is the easiest part to be cleaned using the disclosed method (first cleaning with acid, followed by a caustic cleaning), and showed very good results (100% of the bottles were cleaned by considering 0 and 0.5 scoring “clean”). The bottle shoulders and sides were more challenging to clean, but good cleaning results were achieved using the disclosed method, taking into account the high degree of initial uncleanliness of the bottles. The data further shows that the disclosed method can be used to efficiently clean bottles at reduced temperatures compared to traditional bottle washing technology.

### Examples 2-10

### Identification of Acidic Cleaning Compositions 1-7

Seven (7) Acidic Cleaning Compositions were tested to determine cleaning capability and are identified in Table 4.

TABLE 4
Identification of Acidic Cleaning Compositions 1-7

| Composition | Identification | Vendor |
|---|---|---|
| 1 | Divosan ® OSA-N VS37 | Diversey, Inc. |
| | | (Sturtevant, Wisconsin, USA) |
| 2 | Divosan ® Uniforce VS44 | Diversey, Inc. |
| | | (Sturtevant, Wisconsin, USA) |
| 3 | Divbrau ® VA10 | Diversey, Inc. |
| | | (Sturtevant, Wisconsin, USA) |
| 4 | Beta VA11 | Diversey, Inc. |
| | | (Sturtevant, Wisconsin, USA) |
| 5 | Pascal VA05 | Diversey, Inc. |
| | | (Sturtevant, Wisconsin, USA) |
| 6 | Everite VA06 | Diversey, Inc. |
| | | (Sturtevant, Wisconsin, USA) |
| 7 | Bruspray acid VA19 | Diversey, Inc. |
| | | (Sturtevant, Wisconsin, USA) |

### Example 2

### Testing of Acidic Cleaning Compositions 1-7 at Room Temperature

Acidic Cleaning Compositions 1-7 were diluted at room temperature to the maximum recommended use concentration mentioned in the product information sheets. Two baseline solutions were prepared, NaOH (2% active) at 75-80° C. and NaOH (2% active) with 0.5% additive based on EDTA. 27 bottles classified as “heavily soiled” (bottles were close to the dirtiest bottles found in the global market) were obtained for testing.

For the acidic product cleaning and internal cleaning, a bottle washing apparatus containing a spray nozzle, a flowmeter, a plastic tank, and a pump were used. For cleaning with the hot caustic, the acidic cleaning compositions were poured into the bottle with a magnetic stirrer, which provided mechanical action. With both cleanings, the contact time was 10 minutes and each bottle was rinsed with water after the cleaning. After caustic pre-cleaning followed by acidic cleaning with Acidic Cleaning Compositions 1-7, the bottles were visually inspected and rated using the following rating system: 0=soil completely removed; 1=soil partly removed (small residue); 2=soil not completely removed (obvious residue); 3=soil not removed (massive residue). The results are given below in Table 5.

TABLE 5
Cleanliness Results of Acidic Cleaning Compositions 1-7
at Room Temperature

| | | | | Temperature | Concentra- |
|---|---|---|---|---|---|
| | Bottle 1 | Bottle 2 | Bottle 3 | (° C.) | tion (2%) |
| NaOH + | 0 | 1 | 0 | 77 | 2 + 0.5 |
| additive | | | | | |
| Composition 1 | 1 | 2 | 2 | 22 | 1.5 |
| Composition 2 | 1 | 1 | 2 | 23 | 2.5 |
| Composition 3 | 2 | 0 | 0 | 22 | 4.0 |
| Composition 4 | 1 | 2 | 1 | 22 | 4.0 |
| Composition 5 | 2 | 2 | 2 | 22 | 3.0 |
| Composition 6 | 2 | 1 | 1 | 23 | 5.0 |
| Composition 7 | 2 | 2 | 2 | 22 | 3.0 |

Conclusions from Example 2

The combination of hot caustic with additive provided better cleaning (cleanliness and no contamination). The worst performances were observed for Acidic Cleaning Compositions 5, 6, and 7. It is believed that the combination of different acids (such as in Acidic Cleaning Compositions 3 and 4) helped enhance the cleaning. It was observed that the tested acidic products could not reach the performance of hot caustic in the tested conditions.

### Example 3

### Testing of Acidic Cleaning Compositions 1-4 at 42-45° C.

Acidic Cleaning Compositions 1, 3, and 4 were diluted to the maximum recommended concentration as set forth in the associated product information sheets. Acidic Cleaning Composition 2 was diluted to double the recommended concentration as set forth in the product information sheet. The diluted solutions were maintained at 42-45° C. for the duration of the test. Two control sodium hydroxide solutions (2% active) were also tested at 70-75° C. and 20° C. (room temperature).

Dirty glass bottles classified as “heavily soiled” were obtained and used for testing. Three (3) bottles were tested on a pilot bottle washing machine for each control and each composition with a contact time of 10 minutes.

The level of internal bottle cleanliness was visually estimated as set forth in Example 2. The results of the testing are given below in Table 6.

TABLE 6
Cleanliness Results of Compositions 1-4

| | | | Acidic Cleaning Composition | | | |
|---|---|---|---|---|---|---|
| | NaOH | NaOH | 1 | 2 | 3 | 4 |
| Temperature (° C.) | 70-75 | 20 | 40-45 | 40-45 | 40-45 | 40-45 |
| Concentration | 2% | 2% | 3% | 3.5% | 4% | 4% |
| Bottle 1 Rating | 0 | 0 | 2 | 2 | 0 | 0 |
| Bottle 2 Rating | 0 | 0 | 1 | 1 | 2 | 1 |
| Bottle 3 Rating | 1 | 1 | 0 | 2 | 2 | 2 |

### Summary of the Results for Example 3

The results from Example 3 indicate that caustic (NaOH) even at room temperature showed better results than the Acidic Cleaning Compositions 1-4 without the caustic at higher temperatures.

### Example 4

### Testing of Acidic Cleaning Compositions 1-4 with Caustic Shot

Dirty bottles were tested as in Example 2, with the addition of a caustic shot of NaOH (2% w/w at room temperature) sprayed for 40 seconds and rinsed prior to washing in the acidic solutions for 10 minutes. After the cleaning, each bottle was rinsed with water and rated as set forth in Example 2. The results of the testing are given below in Table 7.

Summary of the Results from Example 4

The results from Example 4 indicate that Acidic Cleaning Compositions 1 and 2 showed the worst cleanliness performance. The addition of the caustic shot step for Acidic Cleaning Compositions 1 and 2 did not improve the cleaning compared to the results from Example 3. Acidic Cleaning Composition 4 gave the best results, comparable to the baseline with hot caustic.

TABLE 7
Cleanliness of Acidic Cleaning Compositions 1-4 with Caustic Shot

| | | Acidic Cleaning Composition | | | |
|---|---|---|---|---|---|
| | NaOH | 1 | 2 | 3 | 4 |
| Temperature (° C.) | 70-75 | 20-30 | 20-30 | 20-30 | 20-30 |
| Concentration | 2% | 3% | 2.5% | 4% | 4% |
| Bottle 1 Rating | 0 | 2 | 2 | 1 | 0 |
| Bottle 2 Rating | 0 | 2 | 0 | 1 | 0 |
| Bottle 3 Rating | 1 | 2 | 2 | 1 | 1 |

The temperature increase from room temperature to 45° C. did not significantly improve the cleaning with the tested compositions. The addition of the caustic shot step had no significant influence on the cleaning performance for Acidic Cleaning Compositions 1 and 2.

### Example 5

### Testing of Acidic Bottle Washng Cleaning at 40° C.

Twelve (12) bottles classified as “heavily soiled” were cleaned using Acidic Cleaning Compositions 3 or 4 at about 40° C. using a pilot bottlewasher (10 minute spraying time for the acid detergent and 2 minute rinse time). After cleaning, the bottles were visually examined for cleanliness as set forth in Example 2. The results are given in Table 8.

### Summary of the Results for Example 5

For bottles 1-6, very tenacious organic soil was still present (bottles 3 and 6) after cleaning. However, it was observed that with Acidic Cleaning Composition 3, most of the soil was gone and only a small amount remained on the bottle surface. For both Acidic Cleaning Compositions 3 and 4, the heavily soiled bottles were cleaned using the acidic detergents at 40° C.

TABLE 8
Cleanliness Results of Acidic Bottle Washing at 40° C.

| | | Rating for Acidic Acid Composition | |
|---|---|---|---|
| Bottle No. | Temperature (° C.) | 3 | 4 |
| 1 | 40.9 | 0 | — |
| 2 | 40.9 | 0 | — |
| 3 | 40.9 | 2 | — |
| 4 | 40.3 | — | 0 |
| 5 | 40.3 | — | 0 |
| 6 | 40.3 | — | 2 |
| 7 | 41.0 | 1 | — |
| 8 | 41.0 | 1 | — |
| 9 | 41.0 | 0 | — |
| 10 | 40.4 | — | 1 |
| 11 | 40.4 | — | 0 |
| 12 | 40.4 | — | 0 |

For bottles 7-12, Composition 4 gave slightly better results on bottles containing molds compared to Composition 3.

### Example 6

### Testing with Caustic Shot at 40° C. before Acid Cleaning

Caustic shot was prepared using NaOH (2% w/w) at 20° C. with 0.5% additive (based on EDTA) to enhance mold removal and 0.01% additive (defoamer) to reduce foam in the caustic bath at 20-25° C. 12 bottles classified as “heavily soiled” were obtained and washed with Compositions 3 or 4.

The bottles were cleaned using a pilot bottlewasher, with spraying time for caustic shot of 40 seconds, rinsing time between caustic and acid of 1 minute, total acid spraying time of 10 minutes, and final rinse time of 2 minutes. After washing, the bottles were inspected and given a level of cleanliness, as set forth in Example 2. The cleanliness results are shown below in Table 9.

TABLE 9
Cleanliness Results of Washing plus Caustic Shot at 40° C.

| | | Rating for Acidic Acid Composition | |
|---|---|---|---|
| Bottle No. | Temperature (° C.) | 3 | 4 |
| 1 | 40.7 | 0 | — |
| 2 | 40.7 | 1 | — |
| 3 | 40.7 | 0 | — |
| 4 | 40.6 | — | 0 |
| 5 | 40.6 | — | 0 |
| 6 | 40.6 | — | 0 |
| 7 | 40.9 | 0 | — |
| 8 | 40.9 | 1 | — |
| 9 | 40.9 | 0 | — |
| 10 | 40.6 | — | 0 |
| 11 | 40.6 | — | 0 |
| 12 | 40.6 | — | 1 |

### Summary of the Results for Example 6

After cleaning with Acidic Cleaning Composition 3, 2 bottles were not cleaned. For Acidic Cleaning Composition 4, one bottle was not cleaned. For bottles 7-12, cleaning performance of Acidic Cleaning Composition 3 and Composition 4, respectively, was comparable.

### Example 7

### Testing with Caustic Shot at 40° C. and Reduced Cleaning Time

For the caustic shot, NaOH at 2% (w/w) and 40° C. with 0.5% additive to enhance very tenacious organic soil removal was prepared. Twelve (12) bottles classified as “heavily soiled” were obtained. The bottles were cleaned using a pilot bottlewasher (spraying time for caustic shot was 40 seconds, rinsing time between caustic and acid was 1 minute, total acid spraying time was 5 minutes, final rinse time was 2 minutes). After the caustic shot, the bottles were cleaned with Composition 3 or 4 and then visually evaluated as set forth in Example 2. The results are shown below in Table 10.

TABLE 10
Cleanliness Results with Caustic Shot at 40° C.

| | | Rating for Acidic Acid Composition | |
|---|---|---|---|
| Bottle No. | Temperature (° C.) | 3 | 4 |
| 1 | 40.2 | 0 | — |
| 2 | 40.2 | 0 | — |
| 3 | 40.2 | 0 | — |
| 4 | 40.8 | — | 0 |
| 5 | 40.8 | — | 1 |
| 6 | 40.8 | — | 0 |
| 7 | 41.7 | 0 | — |
| 8 | 41.7 | 0 | — |
| 9 | 41.7 | 0 | — |
| 10 | 40.8 | — | 2 |
| 11 | 40.8 | — | 0 |
| 12 | 40.8 | — | 0 |

### Summary of Results for Example 7

For Acid Cleaning Composition 3, all bottles were cleaned after using a caustic shot at 40° C. and with the reduced spraying time of the acid. For Acid Cleaning Composition 4, two bottles still contained soil after the cleaning.

### Example 8

### Pre-Cleaning with Caustic Shot at 30° C.

Caustic pre-cleaning treatment was prepared using NaOH at 2% (w/w) with 0.5% additive (based on EDTA) to enhance mold removal and 0.01% additive (defoamer) to reduce the foam in the caustic bath. The temperature of the caustic was 40-45° C., the spraying time for caustic shot was 40 seconds, rinsing time between caustic and acid was 1 minute, the temperature of the acid was 30-35° C., total acid spraying time was 3 minutes, final rinse time was 2 minutes.

Twelve (12) bottles classified as “heavily soiled” were obtained and cleaned using a pilot bottlewasher. Specifically, the bottles were cleaned 4 ways: (1) precleaned with caustic shot at 30° C. +acid cleaning at 30° C., (2) precleaned with caustic shot at 40° C. +acid cleaning at 30° C., (3) caustic shot precleaning at 30° C. +acid cleaning at 40° C., and (4) caustic shot precleaning at 40° C. +acid cleaning at 40° C. After the caustic shot, the bottles were cleaned using Composition 3 and were then visually examined as set forth in Example 2. Results are shown below in Table 11.

TABLE 11
Cleanliness Results of Pre-Cleaning with Caustic + Acid Cleaning

| | 30° C. | | 30° C. | 40° C. |
|---|---|---|---|---|
| | Caustic + | 40° C. Caustic + | Caustic + | Caustic + |
| Bottle No. | 30° C. Acid | 30° C. Acid | 40° C. Acid | 40° C. Acid |
| 1 | 0 | 0 | 0 | 0 |
| 2 | 0 | 1 | 0 | 1 |
| 3 | 1 | 0 | 0 | 2 |
| 4 | 0 | 0 | 0 | 0 |
| 5 | 0 | 1 | 1 | 0 |
| 6 | 0 | 0 | 0 | 0 |
| 7 | 0 | 0 | 2 | 0 |
| 8 | 0 | 0 | 2 | 1 |
| 9 | 2 | 0 | 0 | 0 |
| 10 | 1 | — | — | 0 |
| 11 | 0 | — | — | 0 |
| 12 | 0 | — | — | 0 |

### Summary of Results for Example 8

The data shows that for Acidic Cleaning Composition 3, there were three bottles (of 12, 25%) that were not completely cleaned with caustic shot at 30° C. and acid cleaning at 30° C. For bottles tested with the caustic shot at 40° C. and acidic cleaning at 30° C., two bottles (of 9, 22.2%) were not cleaned completely. The data shows that bottles cleaned with a caustic shot at 30° C. and acidic cleaning at 40° C. exhibited decreased cleaning performance compared to the other conditions tested. For bottles tested with the caustic shot at 40° C. and the acidic cleaning at 40° C., the data shows that several bottles (3 of 9, 33.3%) were not completely cleaned.

### Example 9

### Caustic Shot at 40° C. and Acidic Cleaning at 40° C.

The caustic solutions were prepared using NaOH at 2% (w/w) at 40° C. with 0.5% additive to enhance mold removal and with 0.01% additive to reduce foam in the caustic bath. The caustic solution was also prepared without additive. 9 bottles classified as “heavily soiled” were obtained and cleaned using a pilot bottlewasher (spraying time for caustic shot was 1 minute, rinsing time between caustic and acid was 1 minute, total acid spraying time was 4 minutes, final rinse time was 2 minutes). After caustic pre-cleaning followed by acidic cleaning with Acidic Cleaning Composition 3, the bottles were visually inspected and rated as set forth in Example 2. The results are given below in Table 12.

TABLE 12
Cleanliness Results from Caustic Shot and Acidic Cleaning at 40° C.

| | Caustic 40° C. + Acid | Caustic 40° C. + Acid |
|---|---|---|
| Bottle No. | 40° C. + Additive | 40° C., No Additive |
| 1 | 0 | 0 |
| 2 | 0 | 0 |
| 3 | 0 | 1 |
| 4 | 2 | 0 |
| 5 | 0 | 0 |
| 6 | 0 | 0 |
| 7 | 0 | 2 |
| 8 | 0 | 0 |
| 9 | 0 | 0 |

### Summary of Results for Example 9

The data illustrates that only one bottle tested using caustic shot, acidic detergent, and additive could not be cleaned. For testing done without an additive, two bottles could not be cleaned completely.

### Example 10

### Testing with Modified Acidic Cleaning Composition 3

Thirteen (13) modifications of Acidic Cleaning Composition 3 were prepared (labeled 3.1 through 3.13), as set forth below in Table 13.

TABLE 13
Formulations of Compositions 3.1-3.13

| | Formulation Weight Percent | | | | | | | | | | | | | |
|---|---|---|---|---|---|---|---|---|---|---|---|---|---|---|
| Composition | A | B | C | D | E | F | G | H | I | J | K | L | M | N |
| 3.1 | 19.75 | 60.0 | 9.0 | 9.0 | 0.5 | 0.75 | 1.0 | — | — | — | — | — | — | — |
| 3.2 | 13.0 | 60.0 | 9.0 | 9.0 | 2.0 | 3.0 | 4.0 | — | — | — | — | — | — | — |
| 3.3 | 16.5 | 60.0 | 9.0 | 9.0 | 2.0 | 1.5 | 2.0 | — | — | — | — | — | — | — |
| 3.4 | 17.5 | 60.0 | 9.0 | — | 1.0 | 1.5 | 2.0 | 9.0 | — | — | — | — | — | — |
| 3.5 | 17.5 | 60.0 | 9.0 | — | 1.0 | 1.5 | 2.0 | — | 9.0 | — | — | — | — | — |
| 3.6 | 19.5 | 60.0 | 9.0 | — | 1.0 | 1.5 | 2.0 | 7.0 | — | — | — | — | — | — |
| 3.7 | 21.5 | 60.0 | 9.0 | — | 1.0 | 1.5 | 2.0 | 5.0 | — | — | — | — | — | — |
| 3.8 | 17.5 | 60.0 | — | 9.0 | 1.0 | 1.5 | 2.0 | — | — | 9.0 | — | — | — | — |
| 3.9 | 17.5 | 60.0 | — | 9.0 | 1.0 | 1.5 | 2.0 | — | — | — | 9.0 | — | — | — |
| 3.10 | 23.0 | 60.0 | 9.0 | — | — | — | — | — | — | — | — | 1.5 | 1.5 | 5.0 |
| 3.11 | 13.5 | 60.0 | 7.0 | — | 1.5 | 1.0 | 9.0 | — | — | — | — | 1.0 | 2.0 | 5.0 |
| 3.12 | 14.0 | 60.0 | 9.0 | — | 1.5 | 1.0 | 9.0 | — | — | — | — | 1.0 | 2.0 | 2.5 |
| 3.13 | 15.5 | 60.0 | 9.0 | — | 1.5 | 1.0 | 9.0 | — | — | — | — | 0.5 | 1.0 | 2.5 |

In Table 13:
A = water
B = phosphoric acid (75%)
C = glycolic acid (70%)
D = dipropyleneglycol methylether (100%) (Dowanol ® DPM available from Dow, or Solvenon ® DPM available from BASF)
E = alcohol (C8-C10) alkoxylate (EO/PO) (100%) benzyl capped (Triton ® DF-12, available from Dow)
F = alcohol (C10-guerbet) ethoxylate (3EO) (100%) (Lutensol ® XP30, available from BASF)
G = alkyl (C8-12) propoxylate (10PO) (100%) (Degressal ® SD20, available from BASF)
H = diethyleneglycol butylether (100%)
I = Rhodiasolve ® infinity (100%) available from Rhodia
J = formic acid (85%)
K = sulfuric acid (75%)
L = aminotrimethylene phosphonic acid (50%)
M = alkyl (C8) ether (8EO) carboxylic acid (88%) (Akypo ® LF2, available from Kao)
N = ethylene diamine tetraacetic acid 4Na-salt (40%) (Trilon ® B, available from BASF or Versene ® 100 available from Dow or Dissolvine ® 100-S available from Akzo Nobel)

The caustic compositions were prepared using caustic soda (NaOH) at 2% (w/w) at 40° C. Glass bottles classified as “heavily soiled” were obtained.

TABLE 14
Cleanliness Results of Testing with Compositions 3.1-3.13

| Composition | Bottle 1 | Bottle 2 | Bottle 3 | Bottle 4 | Bottle 5 |
|---|---|---|---|---|---|
| 3 | 2 | 0 | 2 | — | — |
| 3.1 | 1 | 0 | 2 | — | — |
| 3.2 | 2 | 2 | 2 | — | — |
| 3.3 | 1 | 2 | 2 | — | — |
| 3.4 | 1 | 0 | 1 | 2 | 1 |
| 3.5 | 2 | 2 | 1 | 0 | 2 |
| 3.6 | 1 | 1 | 0 | 1 | 2 |
| 3.7 | 2 | 2 | 2 | 2 | 0 |
| 3.8 | 2 | 2 | 1 | 2 | 2 |
| 3.9 | 2 | 0 | 1 | 2 | 1 |
| 3.10* | 2 | 2 | 2 | 2 | 2 |
| 3.11* | 2 | 2 | 2 | 0 | 2 |
| 3.12* | 2 | 2 | 2 | 2 | 0 |
| 3.13* | 2 | 2 | 2 | 2 | 2 |

*without caustic step

For acidic solutions 3, 3.1, 3.2, 3.3, 3.4, 3.5, 3.6, 3.7, 3.8, and 3.9, the bottles were cleaned using a pilot bottlewasher by spraying with the caustic solution at 40-45° C. for 40 seconds, rinsing with room temperature tap water, spraying with the acidic compositions at 40-45° C. for 8 minutes, and then rinsing with tap water. For Compositions 3.10, 3.11, 3.12, and 3.13, bottles were cleaned without the caustic at 40-45° C. for 8 minutes, followed by rinsing with tap water.

After cleaning, the bottles were visually inspected and rated as set forth in Example 2. The results are given below in Table 14.

### Summary of Results for Example 10

Data for Compositions 3.1-3.5 shows that changing the level of surfactant did not have a large influence on the cleaning performance. However, use of butyldiglycol (Composition 3.4) appeared to improve cleaning. From the testing with Compositions 3.6-3.9, butyldiglycol improved the cleaning results until a certain point. Further, the acid change to formic acid (Composition 3.8) did not improve performance. The results using the composition with sulfuric acid (Composition 3.9) showed improved results. The data from the testing of Compositions 3.10-3.13 confirmed the need for the caustic shot.

What is claimed is:

1. A method of cleaning a container said method comprising:
a. providing a container;
b. cleaning the container with an acidic detergent composition at 30-60° C. for 1-15 minutes using a bottlewashing apparatus, wherein the detergent composition having, based on the total weight of the composition:
i. 1-60 weight percent of an acid,
ii. 1-60 weight percent of a solvent, and
iii. 1-10 weight percent of a nonionic surfactant;
c. rinsing the container with water;
d. cleaning the container with caustic solution at 30-60° C. for 0.5-15 minutes; and
e. rinsing the container with potable water.

2. The method of claim 1, wherein the acid is selected from the group consisting of a phosphoric acid, a sulfuric acid, a sulfamic acid, a methylsulfamic acid, a hydrochloric acid, a hydrobromic acid, a hydrofluoric acid, a nitric acid, a hydroxyacetic (glycolic) acid, a citric acid, a lactic acid, a formic acid, an acetic acid, a propionic acid, a butyric acid, a valeric acid, a caproic acid, a gluconic acid, an itaconic acid, a trichloroacetic acid, an urea hydrochloride acid, a benzoic acid, an oxalic acid, a maleic acid, a fumaric acid, an adipic acid, a terephthalic peroxyacetic acid, a peroxyoctanoic acid, and any combination thereof.

3. The method of claim 1, wherein the acidic detergent composition further comprising 1-5 weight percent of an additive based on the total weight of the composition, the additive selected from the group consisting of a sequestrant, a surfactant, a buffer, a biocide, and any combination thereof.

4. The method of claim 1, wherein a pH of the acidic detergent composition is 6.0 or less.

5. The method of claim 1, wherein the solvent comprising one or any combination of water, a butyl diglycol, a diglycol, ethanol, an isopropanol, a 1,2-propylene glycol, and a butylene glycol.

6. The method of claim 1, wherein the nonionic surfactant is selected from the group consisting of a polyalkene oxide, a polyalkylene oxide, an alkanoamide, an alkyl polyethylene oxide, an alkylphenol polyethylene oxide, a polyoxyethylenated alkyl amine oxide, a polyoxyethylenated polyoxypropylene glycol, an alkyl polyglucoside, an alkyl carboxylic acid esters, a polyoxyethylenated mercaptan, an alkyl diglyceride, a polyoxyethylenated alkanolamine, a polyalkoxylated amide, a tertiary acetylenic glycol, a t-octylphenoxypolyethoxyethanol, a polyoxyethylenesorbitan monolaurate, a polyoxyethylenesorbitan monolaurate, a polyoxyethylenesorbitan monopalmitate, a polyoxyethylenesorbitan monostearate, a polyoxyethylenesorbitan monooleate, a polyoxyethylenesorbitan monotrioleate, an (octylphenoxy) polyethoxyethanol, a triethyleneglycol monolauryl ether, a sorbitan monolaurate, and any combination thereof.

7. The method of claim 1, wherein the caustic solution is selected from the group consisting of NaOH, LiOH, KOH, NH₄OH, Mg(OH)₂, Ca(OH)₂, and any combination thereof.

8. The method of claim 1, wherein the caustic solution comprises at least one additive selected from the group consisting of EDTA, EGTA, NTA, DTPA, HEIDA, IDS, MGDA, GLDA, GLUDA, a gluconic acid and/or a gluconate, 2,2′-bipyridyl, phosphonic acid, a complex phosphate, a phosphonate, and any mixture and salt thereof.

9. The method of claim 1, further comprising at least one additional cleaning or pre-rinsing step.

10. The method of claim 1, wherein said container is a container selected from the group comprising glassware and refillable PET.

11. The method of claim 1, wherein:
a. the caustic solution comprising 1-4 weight percent of a caustic comprising 0.2-0.8 weight percent additive, based on the total weight of the caustic solution; and
b. the acidic detergent composition comprising 1-5 weight percent of an acid, based on the total weight of the acid detergent composition.

12. A detergent for use in a bottlewashing apparatus comprising:
a. an acidic-based detergent having, based on the total weight of the composition:
i. 1-60 weight percent of an acid,
ii. 1-60 weight percent of a solvent, and
iii. 1-10 weight percent of a nonionic surfactant,
wherein a pH of the acid-based detergent is less than 6; and
b. a caustic-based detergent,
wherein a pH of the caustic-based detergent is greater than 13.

13. The detergent of claim 12, wherein the acid is selected from the group consisting of a phosphoric acid, a sulfuric acid, a sulfamic acid, a methylsulfamic acid, a hydrochloric acid, a hydrobromic acid, a hydrofluoric acid, a nitric acid, a hydroxyacetic (glycolic) acid, a citric acid, a lactic acid, a formic acid, an acetic acid, a propionic acid, a butyric acid, a valeric acid, a caproic acid, a gluconic acid, an itaconic acid, a trichloroacetic acid, an urea hydrochloride acid, a benzoic acid, an oxalic acid, a maleic acid, a fumaric acid, an adipic acid, a terephthalic peroxyacetic acid, a peroxyoctanoic acid, and any combination thereof.

14. The detergent of claim 12, wherein the acid-based detergent further comprising 1-5 weight percent of an additive based on the total weight of the composition, the additive selected from the group consisting of a sequestrant, a surfactant, a buffer, a biocide, and any combination thereof.

15. The detergent of claim 12, wherein a pH of the acidic detergent composition is 6.0 or less.

16. The detergent of claim 12, wherein the solvent comprising any one or combination of water, a butyl diglycol, a diglycol, ethanol, an isopropanol, a 1,2-propylene glycol, and a butylene glycol.

17. The detergent of claim 12, wherein the nonionic surfactant is selected from the group consisting of a polyalkene oxide, a polyalkylene oxide, an alkanoamide, an alkyl polyethylene oxide, an alkylphenol polyethylene oxide, a polyoxyethylenated alkyl amine oxide, a polyoxyethylenated polyoxypropylene glycol, an alkyl polyglucoside, an alkyl carboxylic acid esters, a polyoxyethylenated mercaptan, an alkyl diglyceride, a polyoxyethylenated alkanolamine, a polyalkoxylated amide, a tertiary acetylenic glycol, a t-octylphenoxypolyethoxyethanol, a polyoxyethylenesorbitan monolaurate, a polyoxyethylenesorbitan monolaurate, a polyoxyethylenesorbitan monopalmitate, a polyoxyethylenesorbitan monostearate, a polyoxyethylenesorbitan monooleate, a polyoxyethylenesorbitan monotrioleate, an (octylphenoxy) polyethoxyethanol, a triethyleneglycol monolauryl ether, a sorbitan monolaurate, and any combination thereof.

18. The detergent of claim 12, wherein the caustic solution is selected from the group consisting of NaOH, LiOH, KOH, NH₄OH, Mg(OH)₂, Ca(OH)₂, and any combination thereof.

19. The detergent of claim 12, wherein the caustic solution comprises at least one additive selected from the group consisting of EDTA, EGTA, NTA, DTPA, HEIDA, IDS, MGDA, GLDA, GLUDA, a gluconic acid and/or a gluconate, 2,2′-bipyridyl, phosphonic acid, a complex phosphate, a phosphonate, and any mixture and salt thereof.

20. A detergent for use in a bottlewashing apparatus comprising:
a. an acidic-based detergent having, based on the total weight of the composition:
i. 1-60 weight percent of an acid, the acid is selected from the group consisting of a phosphoric acid, a sulfuric acid, a sulfamic acid, a methylsulfamic acid, a hydrochloric acid, a hydrobromic acid, a hydrofluoric acid, a nitric acid, a hydroxyacetic (glycolic) acid, a citric acid, a lactic acid, a formic acid, an acetic acid, a propionic acid, a butyric acid, a valeric acid, a caproic acid, a gluconic acid, an itaconic acid, a trichloroacetic acid, an urea fumaric acid, an adipic acid, a terephthalic peroxyacetic acid, a peroxyoctanoic acid, and any combination thereof,
ii. 1-60 weight percent of a solvent, the solvent comprising any one or combination of water, a butyl diglycol, a diglycol, ethanol, an isopropanol, a 1,2-propylene glycol, and a butylene glycol, and
iii. 1-10 weight percent of a nonionic surfactant, the nonionic surfactant is selected from the group consisting of a polyalkene oxide, a polyalkylene oxide, an alkanoamide, an alkyl polyethylene oxide, an alkylphenol polyethylene oxide, a polyoxyethylenated alkyl amine oxide, a polyoxyethylenated polyoxypropylene glycol, an alkyl polyglucoside, an alkyl carboxylic acid esters, a polyoxyethylenated mercaptan, an alkyl diglyceride, a polyoxyethylenated alkanolamine, a polyalkoxylated amide, a tertiary acetylenic glycol, a t-octylphenoxypolyethoxyethanol, a polyoxyethylenesorbitan monolaurate, a polyoxyethylenesorbitan monolaurate, a polyoxyethylenesorbitan monopalmitate, a polyoxyethylenesorbitan monostearate, a polyoxyethylenesorbitan monooleate, a polyoxyethylenesorbitan monotrioleate, an (octylphenoxy) polyethoxyethanol, a triethyleneglycol monolauryl ether, a sorbitan monolaurate, and any combination thereof, wherein a pH of the acid-based detergent is less than 6; and
b. a caustic-based detergent, the caustic solution is selected from the group consisting of NaOH, LiOH, KOH, NH₄OH, Mg(OH)₂, Ca(OH)₂, and any combination thereof
wherein a pH of the caustic-based detergent is greater than 13.
